(19) United States
(12) Patent Application Publication
(10) Pub. No.: US 2015/0221430 A1
(43) Pub. Date: Aug. 6, 2015

(54) Modularized planar coil and planar transformer using the same

(71) Applicant: Wen-Hsiang WU LI, New Taipei (TW)

(72) Inventor: Wen-Hsiang WU LI, New Taipei (TW)

(21) Appl. No.: 14/173,084

(22) Filed: Feb. 5, 2014

(51) Int. Cl. H01F 27/29; H01F 27/28

(52) U.S. Cl. CPC H01F 27/292; H01F 27/2871

(57) ABSTRACT

Disclosed is a planar coil module comprising a first planar coil, a second planar coil and a connection portion to connect the first and second planar coils in series. The first and second coils respectively include an outer loop and an inner loop, connected in series and separated by a first distance, with the inner loops of the first and second planar coils connected by the connection portion. The first and second planar coils are provided in two neighboring planes and are separated by a second distance. The outer loops of the first and second planar coils respectively include an outer terminal away from the inner loop, wherein the outer terminals extend to form a pad. The pad of the first planar coil locates at a first position at peripheral of an imaginary geometric shape that encloses the two planar coils and the pad of the second planar coil locates at a second position apart from the first position at peripheral of the geometric shape. A planar transformer including the invented planar coil module is also disclosed.

### FIELD OF THE INVENTION

The present invention relates to a modularized planar coil, especially to a planar coil module for use in planar transformers. This invention provides a multiple-leveled, multiple-coiled planar coil module, which is modularized and is ready to connect with another coil or coil module. The present invention also provides a planar transformer including the invented planar coil module.

### BACKGROUNDS OF THE INVENTION

The transformer is an important component for all kinds of electronic products. The traditional transformer is bulky and heavy, therefore not useful in most nowadays electronic components. The planar transformer was then invented to provide the possibility of down-sizing and surface-mounting the transformer. A planar transformer includes plural layers of printed circuit boards provided with winding coils of conductive sheets, such as copper sheets, which reduce the thickness of the coils. The planar transformer is widely used in components in the fields of communications, computer, industrial control, aerospace engineering, medication etc. However, because the printed circuit board is used as substrate of the coils, the conventional planar transformer is thick and inefficient and generates high resistance and noises. Therefore, it is necessary for the industry to provide a thin and efficient planar transformer.

Taiwan patent No. TW I 387981 discloses a planar transformer, comprising a single, multilayered printed circuit board (PCB). The PCB includes a plurality of primary winding, a plurality of secondary winding and a through hole for a core to be arranged therein. This patent provides the possibility of laminating a plurality of winding layers in one PCB, whereby the thickness of the transformer is dramatically reduced. The structure disclosed in this patent is substantially identical to the traditional planar transformer, except that the PCB in the traditional planar transformer is replaced by a thin circuit layer.

Taiwan patent No. TW I 357086 provides a transformer arranged in a PCB. The transformer includes a first planar coil and a second planar coil, wherein the first coil includes a plurality of first loop and the second coil includes a plurality of second loop. At least two neighboring first loops form a first bundle of coils and at least two neighboring second loops form a second bundle of coils. The loops of the first bundle partially interpose that of the second.

Chinese patent No. CN 103081044A also discloses a planar transformer. The transformer comprises a plurality of single-layered, single-looped coils. Primary winding and secondary windings are formed by the single layered coils.

European patent EP 2 602 801A1 discloses a planar transformer comprising a secondary winding that includes a plurality of single-layered, single-looped coil layers. The primary winding is formed by a wire wound in a spiral along the secondary winding.

German patent application No. DE 10 2012 003 365A1 discloses a planar transformer that includes windings in the form of a single-layered and multiple-looped, planar structure. The terminal of the inner loop bends to pass a through hole provided at center of substrate on which the planar structure is arranged, to the opposite side of the substrate.

European patent No. EP 2 637 183A2 discloses a planar transformer that includes single-layered, single-looped coil layers as its windings. The coil layers extend to provide pads, to serve as connecting pins with another layer or electrodes.

US patent publication No. US 2013/278371A1 discloses a planar transformer comprising a plurality of single-layered planar coils. A plurality of coils is connected and positioned by terminal pins vertically, to form coils of multiple loops.

WO 0070926A1 discloses a planar transformer including windings made by a single element. A sheet of conductive material is so designed, that when it is bent a multiple-layered, single-looped coil assembly is formed. The layers are connected by tabs in the form of a pad.

From the disclosure of these and other patents and non-patent documents, it is understood that the industry have spent substantial efforts in the development of planar transformer, in order to reduce its thickness and to enhance its performance. However, the structure of the planar transformer so developed remains the same of the PCB-style. Most solutions are the assembly of single-layered coils or coil layers as their units. The connections between two coils or layers are specifically designed, so that they suited only for particular coil structures, i.e., coil assemblies of particular number of layers and loops. None of them has provided modularized designs for the coils, so that coils modules having standard interfaces may be selectively assembled, to form coil assemblies that satisfy the diversified needs in the industry.

### OBJECTIVES OF THE INVENTION

An objective of this invention is to provide a modularized, multilayered and multiple-looped planar coil.

Another objective of this invention is to provide a planar coil module that supports the formation of planar coil assemblies of selected numbers of layers and loops of coils.

Another objective of this invention is to provide a planar transformer that includes a modularized planar coil module.

Another objective of this invention is to provide a planar coil module that is easy to fabricate and usable in surface mounting, and a planar transformer using the same.

### SUMMARY OF THE INVENTION

According to this invention, a novel planar coil module is provided in the form of a multilayered, multi-looped planar coil assembly. The planar coil module comprises a first planar coil, a second planar coil and a connection portion to connect the first and second planar coils in series. In the invented planar coil module, the first and second coils respectively include an outer loop and an inner loop, connected in series and separated by a first distance. The inner loops of the first and second planar coils are connected by the connection portion. The first and second planar coils are provided in two neighboring planes and are separated by a second distance. The outer loops of the first and second planar coils respectively include an outer terminal away from the inner loop. The outer terminals extend to form a pad, wherein the pad of the first planar coil locates at a first position at peripheral of an imaginary geometric shape that encloses the two planar coils and the pad of the second planar coil locates at a second position apart from the first position at peripheral of the geometric shape. The two pads extend in a height direction to a same height or different heights.

In the preferred embodiments of this invention, the geometric shape is a rectangle enclosing the two planar coils, while in other embodiments the geometric shape is a polygon or a circle enclosing the two planar coils.

In some preferred embodiments, the planar coil module further includes an insulation sheet, arranged between the first and second coils. The insulation sheet may comprise a recession, to be engaged by the connection portion.

In some embodiments the first planar coil, the second planar coil and the connection portion are prepared from a single continuous blank. In other embodiments, however, the first planar coil and the second planar coil are prepared separately and connected by the connection portion in a later step. In such embodiments, the connection portion may be a welder or an adhesive, conductive material.

In some embodiments, the first and second coils respectively form a circular spiral. In such embodiments the inner loops and outer loops of the first and second planar coils respectively form substantially a loop. In other embodiments the first and second coils respectively form a non-circular spiral, such as rectangular spiral, a hexagonal spiral, an octagonal spiral or other polygons. In such embodiments, the inner loops and outer loops of the first and second planar coils respectively form substantially a loop.

According to another aspect of this invention, a planar coil assembly is provided and comprises two planar coil modules of this invention as described above. In the assembly, the pad of the first planar coil of a second planar coil module locates at the second position at peripheral of the geometric shape and the pad of the second planar coil of the second planar coil module locates at a third position apart from the first and second positions at peripheral of the geometric shape. The two planar coil modules connect at the second position.

A planar transformer using the modularized planar coil module of this invention may comprise a first planar coil module according to this invention, a third planar coil module stacked on the first planar coil module and a core. The core extends orthogonally to the plane of the two planar coil modules and passes through the central portion of the two coil modules. The third planar coil module includes at least a planar coil or planar coil layer. The planar transformer may further include a casing that encloses the core and the coil portions of the two planar coil modules.

In the preferred embodiments of this invention, the planar transformer may further include a second planar coil module according to this invention, which connects the first planar coil module in series at the second position. It may further include a fourth planar coil module in stack with the first and second planar coil modules. The fourth planar coil module includes at least one planar coil or coil layer. In such embodiments, at least one of the third and fourth planar coil modules is sandwiched by the first and second planar coil modules.

These and other objectives and advantages of this invention will be clearly understood from the detailed description by referring to the following drawings.

### BRIEF DESCRIPTION OF THE DRAWINGS

FIG. 1 shows the structure of a planar transformer including a modularized planar coil module of this invention.

FIG. 2 is the perspective view of one embodiment of the modularized planar coil module of this invention.

FIG. 3 is the perspective view of another embodiment of the modularized planar coil module of this invention.

FIG. 4 shows one example of the connection of two modularized planar coil modules of this invention.

### DETAILED DESCRIPTION OF THE INVENTION

Detailed description to several preferred embodiments of this invention will be given below. It is however appreciated that the detailed description serves only for illustration of certain aspects of this invention, without limitation to the scope of protection.

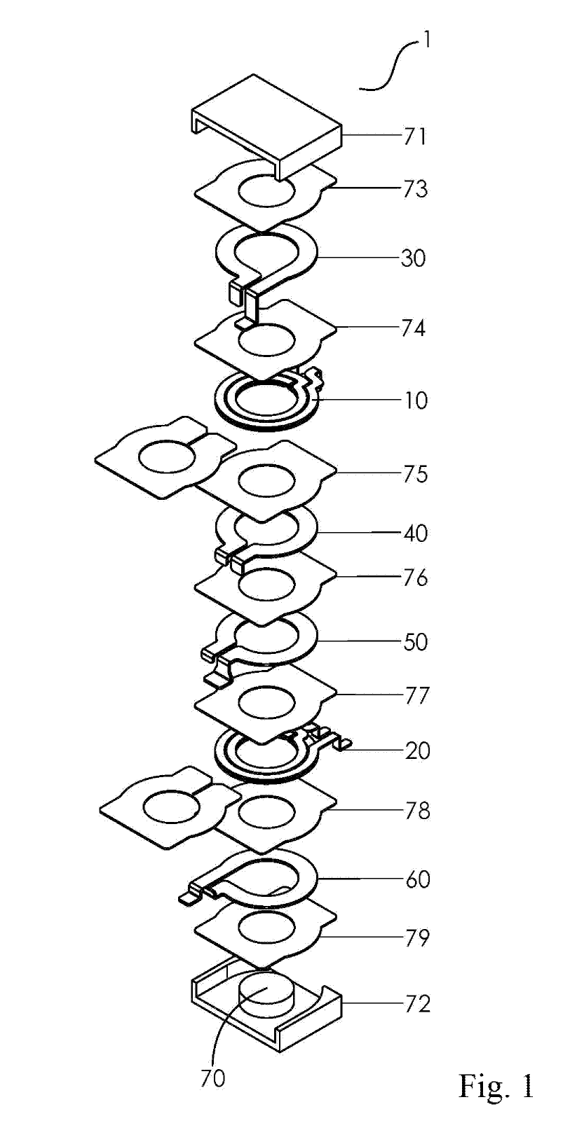

FIG. 1 shows the structure of a planar transformer that includes a modularized planar coil module of this invention. As shown in this figure, the planar transformer 1 includes from top to bottom the following elements: Upper casing 71, insulation sheet 73, first coil layer 30, insulation sheet 74, first planar coil module 10, insulation sheet 75, second coil layer 40, insulation sheet 76, third coil layer 50, insulation sheet 77, second planar coil module 20, insulation sheet 78, fourth coil layer 60, insulation sheet 79, lower casing 72, and a core passing through the central portions of the coil layers, the coil modules and the insulation sheets. In the structure shown in FIG. 1, the first coil layer 30, the second coil layer 40, the third coil layer 50 and the fourth coil layer 60 are connected in series, to function as secondary winding of the transformer 1. The first planar coil module 10 and the second planar coil module 20 are connected in series and function as primary winding of the transformer 1. Of course, in this structure, the first and second windings are interchangeable. For purpose of description, in the following the term “primary winding” will denote to the first planar coil module 10 and/or the second planar coil module 20 and the term “secondary winding” will denote to all or a part of the first coil layer 30, the second coil layer 40, the third coil layer 50 and the fourth coil layer 60. Therefore, in the following description, “primary winding” and “secondary winding” are interchangeable and represent the relative elements of the transformer.

Also as shown in this figure, the primary winding includes two double-layered, double-looped planar coil modules 10 and 20. On the other hand, the secondary winding includes four single-layered, single-looped planar coil layers. As may be appreciated by those having ordinary skills in the art, the secondary winding may include any number of planar coil layers, alone or in combination with one or more than one planar coil module, such as planar coil module 10, 20. Numbers of the primary and secondary windings are not limited by these embodiments. For example, a planar transformer may include one planar coil module as its primary winding and one or two planar coil layers as its secondary winding. It is also possible to include two planar coil modules as its primary winding and one or two planar coil layers as its secondary winding. Preferably, the coils of the primary winding and the secondary winding interleave, so to enhance the performance of the transformer. Insulation sheets may be provided between each two coil layers. Of course, it is possible to provide insulation in other forms, such as insulation layers provided on the surface of the coils. Materials for the insulation sheets or insulation layers are not limited. Commercially available materials may be used, as long as they are easily processed and provide required insulation effects. If insulation sheets are used, thickness of the sheets should be so determined that the insulation sheets are not so thick as to impact the induction of the coils and not so thin as to damage the insulation effects.

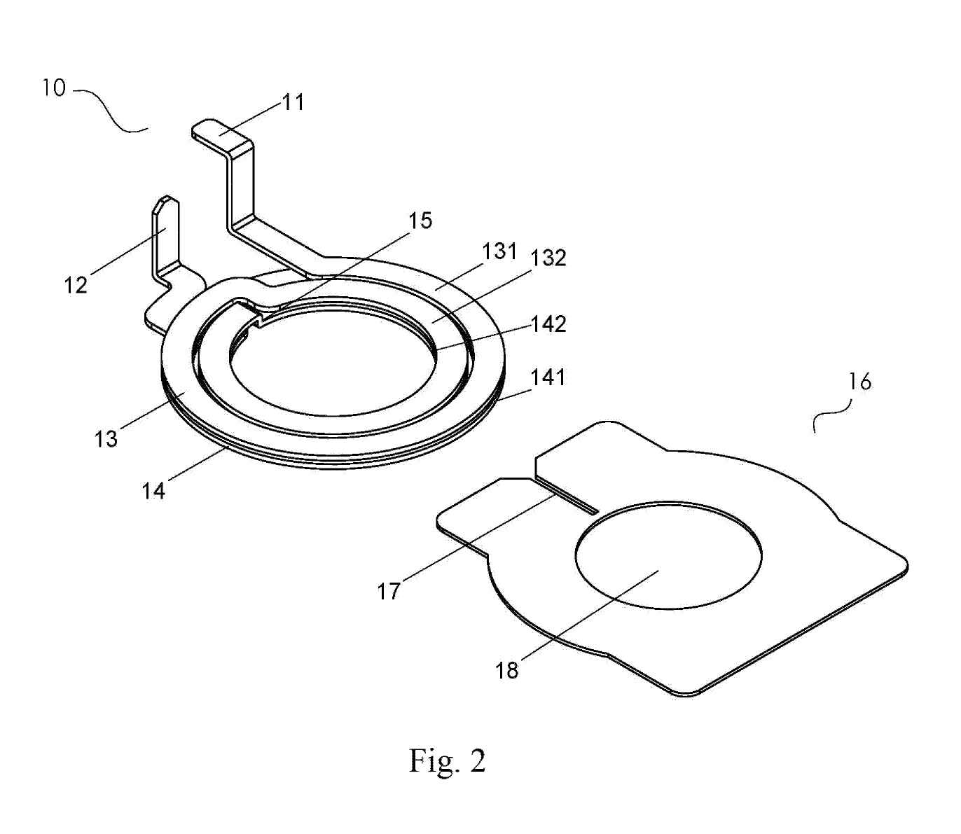

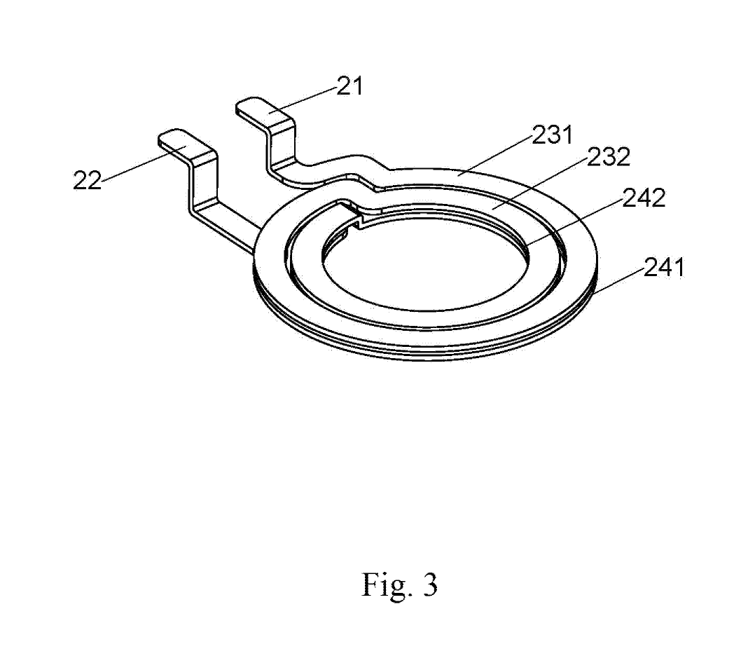

In the structure shown above, coils of the secondary winding may be connected in series in any suitable form. The planar coil modules 10, 20 of the primary winding are two examples of the modularized planar coil module of this invention. As shown in the figure, the planar coil modules 10, 20 respectively have two pads 11, 12 and 21, 22 (referring to FIGS. 2 and 3), extended from the modules. In addition, the planar layers 30, 40, 50, 60 respectively have two pads extended from the coils, at a side opposite to the side where the pads 11, 12, 21, 22 of planar coil modules 10, 20 extend. Of course, the present invention is not limited to such arrangements. It is possible to arrange all or a part of the pads of the primary winding at the side where all or a part of the pads of the secondary winding is arranged.

These elements are assembled to form a planar transformer 1. In the transformer 1, upper casing 71 and lower casing 72 enclose the core 70 and the coil portions of the planar coil modules 10, 20 and the coil layers 30, 40, 50, 60. The casings 71, 72 do not only protect the transformer 1 but also provide EMR shielding functions. Three pads 11, 21, 22 of the planar coil modules 10, 20 (see FIGS. 2 and 3) and several pads of the coil layers 30, 40, 50, 60 bend to form soldering pads, so that the planar transformer 1 may be mounted on a circuit board using the surface mounting (SMT) technology.

In the embodiments of this invention, the planar coil modules 10, 20 and the coil layers 30, 40, 50, 60 are made by materials with high conductivity. Suited materials include all kinds of metal or alloys, such as copper, silver, brass etc. On the other hand, the core 70 may be any type of commercially available cores. The material, shape and size of the core 70 may be determined by those having ordinary skills in the art in accordance with related requirements and conditions in particular applications. In addition, casing for the transformer is not limited to any form. A casing made from one-piece blank or by the assembly of more than two elements may also be used in this invention. If necessary, one of the upper casing and the lower casing may be omitted. It is also possible to use more than one or one layer of upper casing and/or lower casing. These are, of course, not any technical limitation.

FIG. 2 shows the perspective view of one embodiment of the modularized planar coil module of this invention. The planar coil module shown in FIG. 2 corresponds to planar coil module 10 of FIG. 1. Planar coil module 10 includes a first planar coil 13, a second planar coil 14 and connection portion 15 connecting the first planar coil 13 and the second planar coil 14. First planar coil 13 and second planar coil 14 are arranged in two neighboring planes, with a predetermined distance between them. In this embodiment, the first planar coil 13, the second planar coil 14 and the connection portion 15 form a continuous piece of material, preferably from a material of high conductivity. Suited materials include all kinds of metal and alloys, such as copper, silver, brass etc. However, this is not any technical limitation. The single piece that forms the first planar coil 13, the second planar coil 14 and the connection portion 15 may be prepared by any suitable metal process technique, including coating, low temperature deformation, high temperature deformation, cutting, pressing, etching and other known metal process technologies, or any combination thereof.

The first planar coil 13, the second planar coil 14 and the connection portion 15 may also be prepared separately. For example, the first planar coil 13 and the second planar coil 14 may be fabricated separately and are connected using the connection portion 15. In such embodiments, the connection portion 15 may be a welding material or an adhesive conductive material. When such approach is used, care must be taken to ensure the first planar coil 13 and the second planar coil 14 are connected in series by the connection portion 15.

FIG. 2 also shows that first planar coil 13 and second planar coil 14 respectively include an outer loop 131, 141 and an inner loop 132, 142, connected in series and separated by a predetermined distance. Although in this embodiment, each planar coil includes two loops, this is not any technical limitation. It is possible to use more than two loops in any one of the planar coils 13 and 14. Specifically speaking, number of the loop is determined according to factors such as conversion rate, width of loop, distance between neighboring loops and/or diameter of core 70. In addition, width, thickness and even shape of respective loop may also be determined according to conditions in particular applications. Generally speaking, the windings are preferably formed in planar loops, so to save material and to facilitate process of the windings.

In the embodiment shown in FIG. 2, the connection portion 15 connects the inner loops 132, 142 of the two planar coils 13, 14, allowing all loops of the two planar coils 13, 14 to extend in the same direction. That is, the first planar coil 13 and the second planar coil 14 are connected in series, arranged in two neighboring planes and separated by a distance.

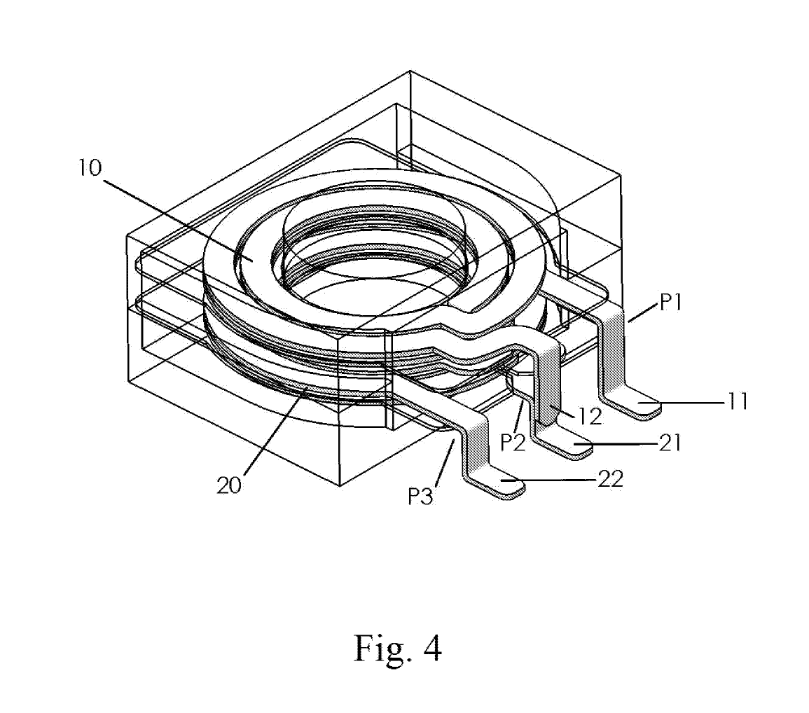

At the outer loops 131, 141 of the two planar coils 13, 14, at the terminal away from their inner loops 132, 142, the coils extend to respectively form a pad 11, 12. According to this invention, the pad 11 of the first planar coil 13 extends at a first position P1 at peripheral of an imaginary geometric shape that encloses the two planar coils and the pad 12 of the second planar coil 14 extends at a second position P2 apart from the first position P1 at peripheral of the imaginary geometric shape. To be more specific, the “imaginary geometric shape” may be a rectangular shape that encloses the regions occupied by the planar coils. For example, the imaginary geometric shape may be the rectangular shape projected by the upper casing 71 and the lower casing 72 on a plane where the pads 11, 12 extend, as shown in FIG. 4. In such a case, the pads 11 and 12 respectively extend at a first position P1 and a second position P2, at one side or two sides of the rectangular shape, as shown in FIG. 4. When used in the SMT technology, first position P1 and second position P2 are respectively arranged at positions of different bonding pads of the planar transformer. In other embodiments, the imaginary geometric shape may be a circle or a polygon that encloses the regions occupied by the planar coil modules, as the imaginary geometric shape may be any shape that serves for the application of the planar transformer. The pads 11, 12 may be bent to form bonding pads for use in the SMT process. In addition, one or more pads 11, 12 may further extend transversely to form bonding pads of large size, to provide securing and/or heat-dissipation functions. In the preferred embodiments of this invention, each pad 11, 12 is arranged at one of the positions where bonding pads of the standard surface mounting device (SMD) locate.

In FIG. 2, both the first planar coil 13 and the second planar coil 14 are circular spiral, i.e., with a circular contour. Such design provides relative higher conversional efficiency. However, the present invention is not limited to spiral or circular windings. Other shapes of the winding, such as rectangular or polygonal spirals that are used in the conventional art, may also be used in this invention. In the windings of FIG. 2, the inner loops 132, 142 and outer loops 131, 141 of the first and second planar coils 13, 14 respectively form substantially a loop. Such design ensures the maximum winding angle of the loops. Of course, this is not any technical limitation. In other embodiments the first and second coil layers respectively form a non-circular spiral, e.g., polygonal spirals such as rectangular spiral, a hexagonal spiral, an octagonal spiral etc. In such embodiments the inner loops 132, 142 and outer loops 131, 141 of the first and second planar coils 13, 14 respectively form substantially a loop, so to obtain maximum winding angles.

In the embodiment of FIG. 2, the planar coil module 10 further includes an insulation sheet 16, sandwiched by the first planar coil 13 and the second planar coil 14 to electrically isolate the two planar coils 13, 14. The material, size and thickness of the insulation sheet 16 are similar to that of insulation sheets 74-79. A recession 17 is provided in the insulation sheet 16, so that the connection portion 15 may plug in the recession 17, to form a robust planar coil module 10. The recession 17 may extend to a depth to be determined in application. However, extension of the recession 17 preferably stops before reaching the hole 18 at center of the insulation sheet 16.

If necessary, adhesives may be applied to one or both surfaces of the insulation sheet 16, to secure the first planar coil 13 and/or the second planar coil 14 on the insulation sheet 16. In addition, when desirable, insulation layer (not shown) may be applied to the winding surface of the first planar coil 13 and/or the second planar coil 14, so to enhance isolation of the windings.

When assembly, the windings of the planar coil module 10 are preferably overlapped by the windings of the coil layers 30, 40 (FIG. 1). Of course, it is possible to so arrange that coils of the primary windings offset or interpose that of the secondary windings.

FIG. 3 shows the perspective view of another embodiment of the modularized planar coil module of this invention. As shown in this figure, the planar coil module of this embodiment corresponds to planar coil module 20 in FIG. 1. The structure of the planar coil module 20 is substantially identical to that of planar coil module 10, except that pads 21, 22 extended from its outer loops 231, 241 at terminals away from the inner loops 232, 242 are respectively arranged at a second position P2 at peripheral of an imaginary geometric shape that encloses the two planar coils and a third position P3 apart from the second position P2 at peripheral of the imaginary geometric shape (FIG. 4). In the example of FIG. 4, the imaginary geometric shape is a rectangle that coincides the upper casing 71 and the lower casing 72 at a plane. In such a case, the pads 21, 22 respectively extend at second position p2 and third position P3 at one side or both sides of the rectangle. In other words, the second position P2 relatively to the imaginary geometric shape is the position where pad 12 of the second planar coil 14 in FIG. 2 extends. When used in SMT, the second position P2 and third position P3 are respectively arranged at positions corresponding to bonding pads of the planar transformer. According to the present invention, when two planar coil modules respectively have one pad provided at the same position relatively to the imaginary geometric shape, the two pads may be lapped to electrically connect the two modules in series.

FIG. 4 shows one example of the connection of two planar coil modules of this invention. In this figure, the square in dotted lines represents possible shape of a packaged planar transformer including two planar coil modules of this invention. As shown in this figure, when assembling the two planar coil modules 10, 20, the two planar coil modules 10, 20 are stacked, maintaining in separation by a predetermined distance and the pads extending at the same position relatively to the imaginary geometric shape, i.e. the rectangular in dotted lines, are lapped and secured. An assembly of two planar coil modules is thus obtained. Any commercially available method may be used to affix the planar coil modules. Usable methods include welding, adhesion, cold forging, fusion etc., as long as the planar coil modules are in secured electrical connection. FIG. 4 also shows that pad 11 of planar coil module 10 and pads 21, 22 of planar coil module 20 respectively bend and further extend to form bonding pads, to facilitate contacts with welding pads provided in circuit boards. Since planar coil module 10 is relatively distanced from the circuit board, its pads 11, 12 extend relatively long in the height direction. As planar coil module 20 is relatively close to the circuit board, its pads 21, 22 extend a shorter distance in the height direction. As such, they may extend to reach the same plane/height. In addition, because pad 12 of planar coil module 10 is provided simply for lapping with pad 21 of planar coil module 20, it does not bend to form a welding pad.

In the particular example shown in FIG. 4, order of the series connection is: From pad 11 at the first position P1 to outer loop 131, then to inner loop 132, both in first planar coil 13 of the planar coil module 10, in second from top level in the figure. The connection continues to inner loop 142, then to outer loop 141, both in second planar coil 14 of the planar coil module 10, in top level in the figure, and to pad 12 at the second position P2. From there, the connection goes to the lapped pad 21 of the second planar coil module 20 at the second position P2, then to outer loop 231 and inner loop 232 of first planar coil 23 at bottom level in the figure. The connection continues to inner loop 242 and outer loop 24 of the second planar coil 24 at the third level in the figure and stops at pad 22 at the third position P3.

When planar coil module 10 and planar coil module 20 are connected in series, a winding structure of 4 layers of double loop is obtained. Three bonding pads are provided in the winding structure, to be bonded to welding pads of a circuit board using the SMT or other technologies. Of course, if only two bonding pads are needed, bonding pad 21 may be omitted, whereby pad 21 simply serves to lap with pad 12. However, the bonding pad is preferably provided to stabilize the structure of the planar coil assembly, even if electrical or electronic connection is not necessary.

It is appreciated that the example shown in FIG. 4 is only one possible embodiment of this invention. Since this invention has provided a modularized structure of the planar coil, each planar coil module has a substantially identical main body structure. The modularized structure provides designers the possibility of realizing a variety of planar coil modules by changing only certain factors of the module, such as position and length/height of pads, according to the needs in particular applications. Planar coil modules of different number of layers and loops may be easily obtained. For example, connections of the planar coils may be made in an order from top level, second level, third level to bottom level, or any other. In addition, pads 11, 12 of planar coil module 10 may be extended, to accommodate any number of layers of winding, or other electronic components, between the two planar coils.

As described above, the present invention provides a modularized structure for the planar coils. The modularized planar coil module is a multiple-layered, multiple-looped structure and provides a wide degree of freedom in designing the planar coil module. The windings of the planar coil module may be made from a single blank and is easy to fabricate and assemble. The modularized pads of the planar coils provide the possibility of connecting a plurality of planar coils in series. The invention allows a designer to design a planar coil module with necessary number of layers and/or loops. No printed circuit board is needed in the preparation of the invented planar coil module. Thickness and footprint of the planar transformer are thus dramatically reduced. In addition, because a multi-layered, multi-looped planar coil module may be fabricated as one single piece of material, resistance generated in the module is reduced and performance is thus enhanced.

What is claimed is:

1. A planar coil module, comprising a first planar coil, a second planar coil and a connection portion to connect the first and second planar coils in series;
wherein the first and second coils respectively include an outer loop and an inner loop, connected in series and separated by a first distance, with the inner loops of the first and second planar coils connected by the connection portion;
wherein the first and second planar coils are provided in two neighboring planes and are separated by a second distance;
wherein the outer loops of the first and second planar coils respectively include an outer terminal away from the inner loop, wherein the outer terminals extend to form a pad; and
wherein the pad of the first planar coil locates at a first position at peripheral of an imaginary geometric shape that encloses the two planar coils and the pad of the second planar coil locates at a second position apart from the first position at peripheral of the geometric shape.

2. The planar coil module according to claim 1, wherein the two pads extend in a height direction to a same height.

3. The planar coil module according to claim 1, wherein the two pads extend in a height direction to different heights.

4. The planar coil module according to claim 1, wherein the geometric shape is a rectangle enclosing the two planar coils.

5. The planar coil module according to claim 1, wherein the geometric shape is a polygon enclosing the two planar coils.

6. The planar coil module according to claim 1, further including an insulation sheet, arranged between the first and second coils.

7. The planar coil module according to claim 6, wherein the insulation sheet comprises a recession, to be engaged by the connection portion.

8. The planar coil module according to claim 1, wherein the first planar coil, the second planar coil and the connection portion are prepared from a single continuous blank.

9. The planar coil module according to claim 1, wherein the connection portion is one selected from the group consisted of a welder and an adhesive and conductive material.

10. The planar coil module according to claim 1, wherein the first and second coil respectively form a circular spiral and the inner loops and outer loops of the first and second planar coils respectively form substantially a loop.

11. The planar coil module according to claim 1, wherein the first and second coils respectively form a polygonal spiral and the inner loops and outer loops of the first and second planar coils respectively form substantially a loop.

12. A planar coil assembly, comprising at least a first planar coil module and a second planar module,
wherein each planar coil module comprises a first planar coil, a second planar coil and a connection portion to connect the first and second planar coils in series;
wherein the first and second coils respectively include an outer loop and an inner loop, connected in series and separated by a first distance, with the inner loops of the first and second planar coils connected by the connection portion;
wherein the first and second planar coils are provided in two neighboring planes and are separated by a second distance; and
wherein the outer loops of the first and second planar coils respectively include an outer terminal away from the inner loop, wherein the outer terminals extend to form a pad;
wherein the pad of the first planar coil locates at a first position at peripheral of an imaginary geometric shape that encloses the two planar coils and the pad of the second planar coil locates at a second position apart from the first position at peripheral of the geometric shape;
wherein the pad of the first planar coil of the second planar coil module locates at the second position at peripheral of the geometric shape and the pad of the second planar coil of the second planar coil module locates at a third position apart from the first and second positions at peripheral of the geometric shape; and
wherein the two planar coil modules connect at the second position.

13. The planar coil assembly according to claim 12, wherein the 4 pads extend in a height direction to a same height.

14. The planar coil assembly according to claim 12, wherein the geometric shape is a rectangle enclosing the two planar coils.

15. The planar coil assembly according to claim 12, further including two insulation sheets, each arranged between the first and second coils of the respective planar coil modules.

16. The planar coil assembly according to claim 15, wherein the insulation sheet comprises a recession, to be engaged by the connection portion.

17. The planar coil assembly according to claim 1, wherein the first planar coil, the second planar coil and the connection portion of each planar coil module are prepared from a single continuous blank.

18. The planar coil assembly according to claim 12, wherein the connection portion is one selected from the group consisted of a welder and an adhesive and conductive material.

19. The planar coil assembly according to claim 12, wherein the first and second coil of the respective planar coil modules respectively form a circular spiral and the inner loops and outer loops of the first and second planar coils respectively form substantially a loop.

20. A planar transformer, comprising a first planar coil module, a third planar coil module stacked on the first planar coil module and a core,
wherein the first planar coil module comprises a first planar coil, a second planar coil and a connection portion to connect the first and second planar coils in series;
wherein the first and second coils respectively include an outer loop and an inner loop, connected in series and separated by a first distance, with the inner loops of the first and second planar coils connected by the connection portion;
wherein the first and second planar coils are provided in two neighboring planes and are separated by a second distance;
wherein the outer loops of the first and second planar coils respectively include an outer terminal away from the inner loop, wherein the outer terminals extend to form a pad; and
wherein the pad of the first planar coil locates at a first position at peripheral of an imaginary geometric shape that encloses the two planar coils and the pad of the second planar coil locates at a second position apart from the first position at peripheral of the geometric shape;
wherein the third planar coil module includes at least a planar coil; and
wherein the core extends orthogonally to the plane of the two planar coil modules and passes through the central portion of the two coil modules.

21. The planar transformer according to claim 20, further comprising a casing enclosing the core and the coil portions of the two planar coil modules.

22. The planar transformer according to claim 20, further comprising a second planar coil module, said second planar coil module comprising a first planar coil, a second planar coil and a connection portion to connect the first and second planar coils in series;
wherein the first and second coils respectively include an outer loop and an inner loop, connected in series and separated by a first distance, with the inner loops of the first and second planar coils connected by the connection portion;
wherein the first and second planar coils are provided in two neighboring planes and are separated by a second distance; and
wherein the outer loops of the first and second planar coils respectively include an outer terminal away from the inner loop, wherein the outer terminals extend to form a pad;
wherein the pad of the first planar coil of the second planar coil module locates at the second position at peripheral of the geometric shape and the pad of the second planar coil of the second planar coil module locates at a third position apart from the first and second positions at peripheral of the geometric shape; and
wherein the two planar coil modules connect at the second position.

23. The planar transformer according to claim 22, wherein the third planar coil modules is arranged between the first and second planar coil modules.

24. The planar transformer according to claim 22, further comprising a metal casing to enclose the core and the coil portions of the three coil modules.
